(19) United States
(12) Patent Application Publication
(10) Pub. No.: US 2010/0145766 A1
(43) Pub. Date: Jun. 10, 2010

(54) METHOD AND APPARATUS FOR PROVIDING PARTICIPATORY MEDIA CONTENT

(76) Inventors: LEE BEGEJA, Gillette, NJ (US); DAVID GIBBON, Lincroft, NJ (US); PAUL VAN VLECK, Austin, TX (US)

Correspondence Address: AT & T LEGAL DEPARTMENT - WT, PATENT DOCKETING, ROOM 2A-207, ONE AT& T WAY, BEDMINSTER, NJ, 07921, US

(21) Appl. No.: 12/329,161

(22) Filed: Dec. 5, 2008

(51) Int. Cl. G06Q 30/00; G06Q 50/00

(52) U.S. Cl. 705/10; 705/26; 705/14.25; 705/14.66

(57) ABSTRACT

A method and apparatus for providing participatory media content to a customer via a network are disclosed. For example, a method receives a request for a first content from a customer, and determines if the customer is associated with a service that provides a participatory media content. The method then selects one or more participatory media content for the customer, if the customer is associated with the service; and provides the customer with the one or more participatory media content and the requested first content.

The present invention relates generally to communication networks and, more particularly, to a method and apparatus for providing participatory media content in a packet network, e.g., Internet Protocol (IP) network, Virtual Private Network (VPN), etc.

### BACKGROUND OF THE INVENTION

Enterprises spend tremendous amount of resources to grow their business and expand their customer base. For example, enterprises may distribute advertising providing information to potential customers. However, the advertising (ad) is distributed with the hope of having potential customers view the ad. Unfortunately, customers often perceive ads as inconveniences or an intrusion that may benefit the enterprise but not the viewers. Hence, regardless of the amount of resources spent to craft the content of an ad, potential customers may simply choose not to view the ad. For example, if the advertising is distributed electronically, a potential customer may simply avoid the ad by clicking away from the ad.

### SUMMARY OF THE INVENTION

In one embodiment, the present invention discloses a method and apparatus for providing participatory media content to a customer via a network. For example, a method receives a request for a first content from a customer, and determines if the customer is associated with a service that provides a participatory media content. The method then selects one or more participatory media content for the customer, if the customer is associated with the service; and provides the customer with the one or more participatory media content and the requested first content.

### BRIEF DESCRIPTION OF THE DRAWINGS

The teaching of the present invention can be readily understood by considering the following detailed description in conjunction with the accompanying drawings, in which:

FIG. 1 illustrates a block diagram depicting an illustrative network related to the current invention;

FIG. 2 illustrates an illustrative network with the current invention for providing participatory media content;

FIG. 3 illustrates a flowchart of a method for providing participatory media content; and

FIG. 4 illustrates a high-level block diagram of a general-purpose computer suitable for use in performing the functions described herein.

To facilitate understanding, identical reference numerals have been used, where possible, to designate identical elements that are common to the figures.

### DETAILED DESCRIPTION

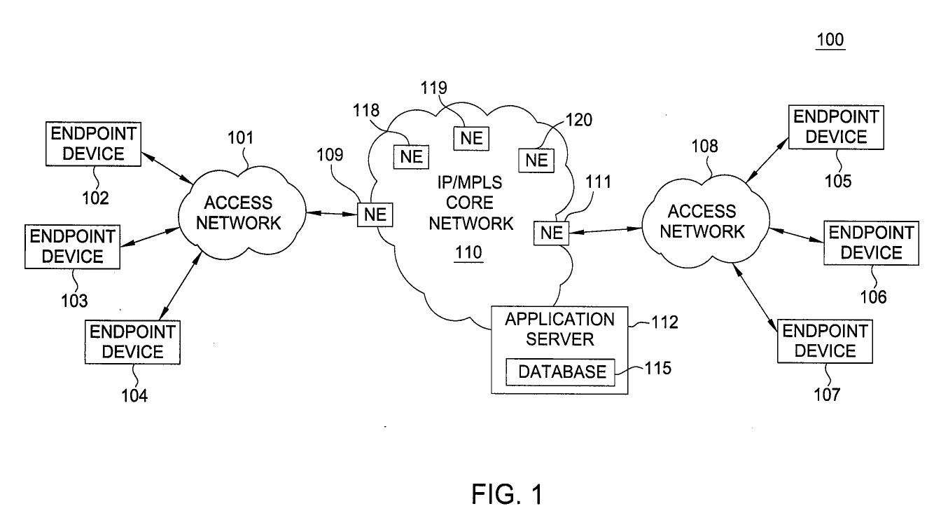

The present invention broadly discloses a method and apparatus for providing participatory media content in a packet network, e.g., an Internet Protocol (IP) network, a Virtual Private Network (VPN), and the like. FIG. 1 is a block diagram depicting an illustrative network 100 related to the current invention. Exemplary networks include Internet protocol (IP) networks, Ethernet networks, and the like. An IP network is broadly defined as a network that uses Internet Protocol such as IPv4 or IPv6, and the like to exchange data packets.

In one embodiment, the network 100 may comprise a plurality of endpoint devices 102-104 configured for communication with the core packet network 110 (e.g., an IP based core backbone network supported by a service provider) via an access network 101. Similarly, a plurality of endpoint devices 105-107 are configured for communication with the core packet network 110 via an access network 108. The network elements 109 and 111 may serve as gateway servers or edge routers for the network 110.

The endpoint devices 102-107 may comprise customer endpoint devices such as personal computers, laptop computers, Personal Digital Assistants (PDAs), servers, routers, and the like. The access networks 101 and 108 serve as a means to establish a connection between the endpoint devices 102-107 and the Network Elements (NEs) 109 and 111 of the IP/MPLS core network 110. The access networks 101 and 108 may each comprise a Digital Subscriber Line (DSL) network, a broadband cable access network, a Local Area Network (LAN), a Wireless Access Network (WAN), a 3^{rd} party network, and the like. The access networks 101 and 108 may be either directly connected to NEs 109 and 111 of the IP/MPLS core network 110, or indirectly through another network.

Some NEs (e.g., NEs 109 and 111) reside at the edge of the core infrastructure and interface with customer endpoints over various types of access networks. An NE that resides at the edge of a core infrastructure is typically implemented as an edge router, a media gateway, a border element, a firewall, a switch, and the like. An NE may also reside within the network (e.g., NEs 118-120) and may be used as a mail server, a router, or like device. The IP/MPLS core network 110 also comprises an application server 112 that contains a database 115. The application server 112 may comprise any server or computer that is well known in the art, and the database 115 may be any type of electronic collection of data that is also well known in the art.

Those skilled in the art will realize that although only six endpoint devices, two access networks, five network elements and one application server are depicted in FIG. 1, the communication system 100 may be expanded by including additional endpoint devices, access networks, network elements, and/or application servers, without altering the scope of the present invention.

The above IP network is described to provide an illustrative environment in which packets for voice, data, and/or multimedia (e.g., video) services are transmitted on networks. Enterprise customers may distribute advertising (ad) to their potential customers over a network, e.g., an IP network. However, a large percentage of potential customers may fail to view the ad.

In one embodiment, the present invention provides a method and an apparatus for providing participatory media content. Participatory refers to a model in which a viewer actively opts to receive the media content. The viewer may be opting to a service for receiving the media content in exchange for receiving a reward. The rewards may be a share of the ad revenues, discounted or free services, discounted or free content upon viewing a predetermined amount of media content, and so on.

In one example, a network service provider may have a service that is ad supported. The viewer may then receive the ad supported services in exchange for viewing the ads. For example, a network service provider may enable customers who opt to receive ads to get the network services at a discount. For example, a cellular service provider may offer customers who view a predetermined amount of ads on their cell phone in a predetermined length of time (e.g., a month, a week, and so on) to have the monthly fees for their cellular service waved or reduced. Alternatively, the reward may comprise additional free minutes or air time for the cellular service.

In one embodiment, the media content may be an advertisement for a product or service unrelated to the content the viewer is receiving, or may be an offer to entice the viewer to get the product or service he/she is already searching for within a limited time. For example, the viewer may be receiving content regarding a book about a specific topic (e.g. a book description, sample pages, etc). The viewer may receive an ad for other books on the same topic, ad for the same book currently being offered by an online retailer, ad for a book store that currently carries the book, or other media content unrelated to what is currently being viewed (e.g., ad for a coffee house, ad for a newspaper or magazine subscription, and so on).

In one embodiment, the participatory media content may be derived from a profile of a viewer. For example, a viewer who opts to receive participatory media content may provide customer inputs that will be stored in a customer profile by the service provider. The profile may be used to determine the ads for a particular viewer. For example, a viewer X may specify disliking sports and liking movies. For the viewer X, an ad containing an endorsement for a product by a movie star may then be more appropriate than an ad containing an endorsement by an athlete. In another example, an ad for discounted movie tickets will be more appropriate than an ad for discounted tickets for a sports event.

In one embodiment, a profile of a viewer or customer may be established or updated automatically and unobtrusively by performing an analysis of the content of a media stream the viewer is obtaining. For example, if a viewer is watching football related content or retrieving sports scores for professional sports teams, then the viewer's profile may be automatically updated to indicate that the viewer has a preference for football or sports in general. In another example, if a viewer is requesting or viewing contents from an electronics retailers, then the viewer's profile may be automatically updated to indicate that the viewer has a preference for electronics. It should be noted that the analysis can be performed to a finer granularity, e.g., a preference for sports can be narrowed down to a particular sports or to a particular sports team, and a preference for electronics can be narrowed down to a particular type of electronics (e.g., cameras) or to a particular brand (e.g., Sony), and so on.

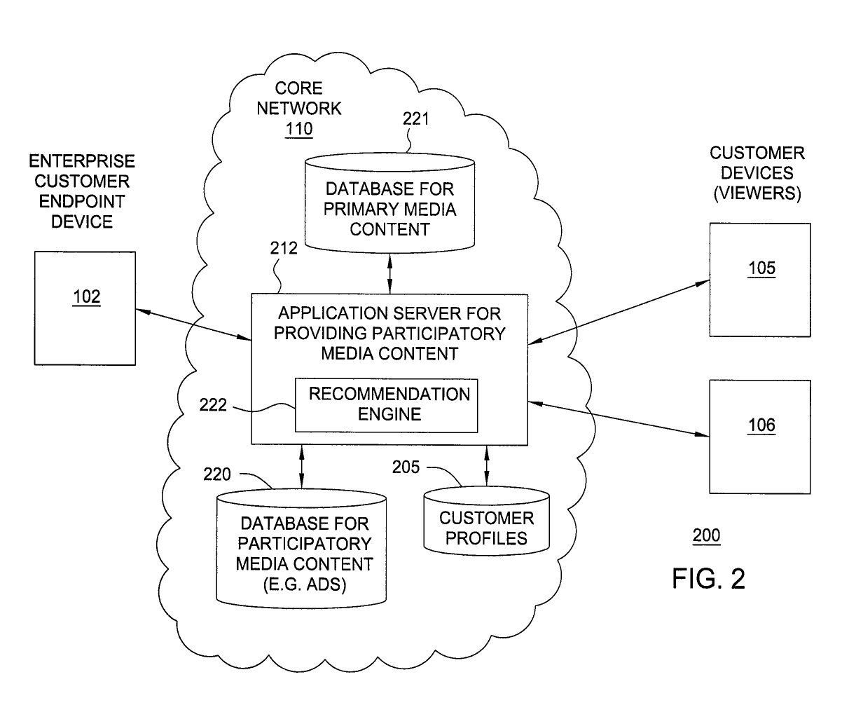

FIG. 2 illustrates an illustrative network 200 with the current invention for providing participatory media content. In one embodiment, the network 200 comprises an enterprise customer endpoint device 102 configured for communication with the service provider's core network 110. Similarly, customer endpoint devices 105 and 106 are configured for communicating with the core network 110. The users of customer endpoint devices 105 and 106 are potential viewers of ads provided by enterprise customer 102. In one embodiment, the core network 110 comprises an application server 212 for providing the participatory media content, a database for storing customer profiles 205, a database for storing primary media content (e.g., movies, videos, music, search results, and the like) 221, and a database for storing participatory media content (e.g. ads) 220. In one embodiment, the application server 212 for providing participatory media content may also comprise a recommendation engine 222.

The customer endpoint devices 105 and 106 may be used by viewers to interact with application server 212 for subscribing to receive the participatory media content. For example, a customer may actively opt-in to a service for receiving and viewing ads from various enterprises in exchange for receiving services at a discount or in exchange for receiving rewards, e.g., free media content, coupons for obtaining various products and/or services for free or at a reduced price.

In one embodiment, the enterprise customer endpoint device 102 may be used to interact with application server 212 for storing participatory media content (e.g. ads) in database 220, wherein the participatory media content can be selectively distributed to potential viewers who actively opt to receive such content. For example, if a user of customer endpoint device 105 actively opts to receive participatory media content (e.g., ads), the application server enables one or more ads stored in database 220 to be viewed by the user.

In one embodiment, the database for storing customer profiles 205 is used to store information that enables the application server 212 to determine which particular participatory media content should be sent to which viewer. For example, a profile is updated or created when customers subscribe to services or when customers actively opt in to receive the participatory media content. In another example, the database 205 may be populated by analyzing the stream of media being received by each customer. For example, a customer may view a primary media content (e.g. movies) of a specific theme, era, etc. The customer profile may then be populated with data of the customer's interest in this type of movies such that the data can be used by a recommendation engine 222 for recommending certain ads to be sent to a particular customer.

In one embodiment, the recommendation engine 222 may be used to choose a list of participatory media content for a customer. For example, the recommendation engine 222 may use customer profiles, primary media content and participatory media content to determine a specific list of content for each customer or a group of customers.

In one embodiment, the participatory media contents stored in database 220 may be associated with different rewards. For example, viewing a test ad may have additional rewards. In another example, the ad revenue received from the enterprise customers by the network service provider may be variable and the network service provider may wish to entice its customers to view certain ads that are associated with higher revenue. Hence, the recommendation engine 222 may also take into account potential revenues and rewards associated with each participatory media content in choosing a list of media content for a customer.

In one embodiment, the customer may actively specify a predefined reward as a condition for receiving each participatory media content. For example, a customer may demand that $0.10 be rewarded for each participatory media content that is sent to the customer. Thus, one novel aspect of this embodiment is that the customer actively defines the reward that he or she will receive instead of allowing the service provider to select a reward for the customer.

In one embodiment, the customer may actively auction his or her time to the bidder who will offer the highest reward as a condition for the customer receiving each participatory media content. For example, a customer is willing to receive a participatory media content only from a highest bidder. To illustrate, if advertiser 1 is willing to pay a customer to view its participatory media content for $0.15, and if advertiser 2 is willing to pay a customer to view its participatory media content for $0.25, then only the participatory media content from advertiser 2 (the highest bidder) will be sent to the customer. In one embodiment, the offered or bid prices of all the advertisers are made publically available so that the advertisers can continuously bid against each other (e.g., based on different time of the day, based on different day of the week, based on the type of customer via the customer profile, and so on) to gain access to the customer's viewing time. For example, if a customer is willing to receive one participatory media content every hour (e.g., 1:00 pm, 2:00 pm, and so on), then as the time approaches each hour, advertisers can bid against each other so that its ad will be presented to the customer.

In one embodiment, the service provider may enable customers to opt-out of receiving participatory media content. In other words, under this implementation, a network service provider may deem participation in receiving participatory media content as a default. This approach may be appropriate if most of the customers of a network service provider prefer to receive the participatory media content. Thus, it may be more practical to keep track of the few customers who choose not to receive the participatory media content. The service provider may then enable the customers to opt-out of receiving the participatory media content, because certain customers may not want any ads to be presented to them irrespective of the offered rewards.

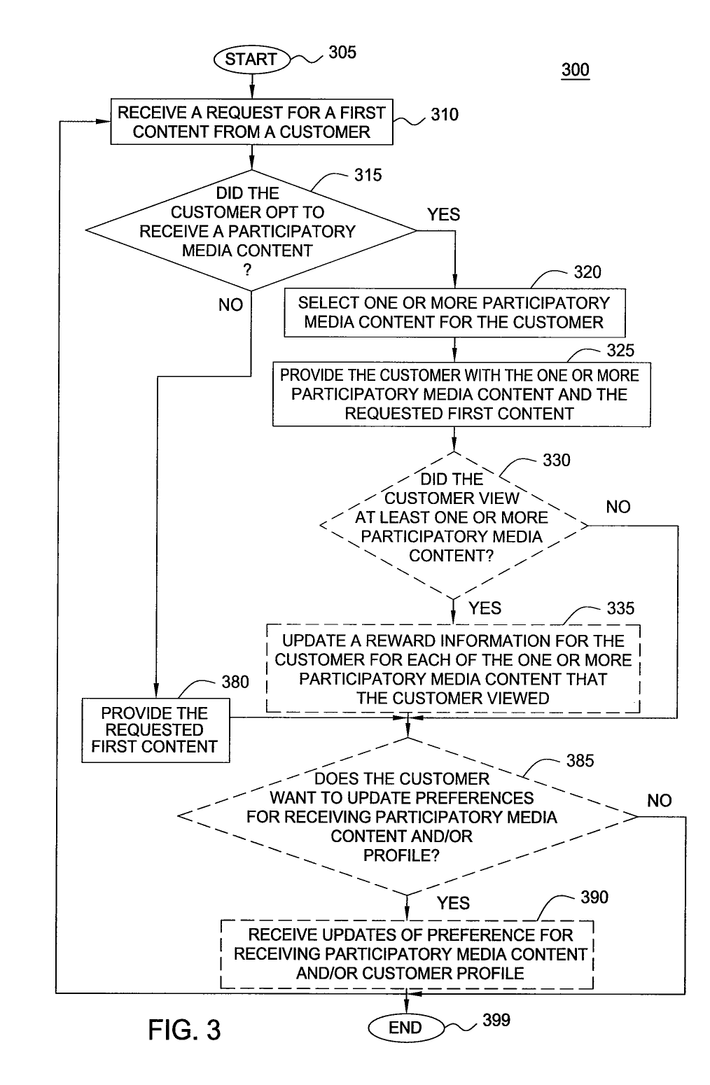

FIG. 3 illustrates a flowchart of a method 300 for providing participatory media content in a network. For example, one or more steps of the method 300 can be implemented by an application server. Method 300 starts in step 305 and proceeds to step 310.

In step 310, method 300 receives a request for a first content from a customer. For example, an application server receives a request from a customer to obtain a media content for viewing, e.g., video, data, etc. Note that, the requested content is to be retrieved from a database containing the primary media content and not the participatory media content.

In step 315, method 300 determines if the customer has opted to receive participatory media content. In other words, the method broadly determines whether a customer is associated with a service that provides participatory media content. If the customer has opted to receive participatory media content, the method proceeds to step 320. Otherwise, the method proceeds to step 380.

In step 320, method 300 selects one or more participatory media content for the customer. For example, the method may select a list of participatory media content, e.g., one or more ads, based on the customer's profile. The method then proceeds to step 325.

In step 325, method 300 provides the customer with the one or more participatory media content and the requested first content. For example, the method may provide the primary content the customer requested along with a sequence of ads that the customer may view, e.g., as pop-up windows, as presented in a split screen format, and so on. It should be noted that the manner as to how the participatory media content will presented to the customer can be tailored to the requirements of a particular implementation. For example, the manner of viewing the participatory media content can be constrained by the capability of the customer endpoint device. If the customer endpoint device has a large display, then the primary media content can be displayed in one window or screen, while the participatory media content is displayed in a separate window or screen.

In optional step 330, method 300 determines whether the customer viewed at least one of the one or more participatory media content. For example, the customer may click away from some ads and view other ads. If the customer viewed none of the one or more participatory media content the method proceeds to step 385.

In optional step 335, method 300 updates the reward information for the customer to account for each of the one or more participatory media content that the customer has viewed. For example, the customer may have viewed 5 ads and skipped 3 ads. The method may then accrue reward points for each of the 5 ads that the customer has viewed. In other words, the manner of viewing the participatory media content can be tied to the manner of awarding the rewards to the customer. For example, an active feedback received from the customer in interacting with an ad (e.g., clicking something on the displayed ad) may produce or accumulate a greater reward for the customer than passively allowing an ad to be temporarily displayed on the customer endpoint device. In one embodiment, the reward points can be accrued and used to determine an appropriate level of rewards to be given to the customer (e.g., a fractional share of the total ad revenue received by the network service provider, a discount for services or goods, coupons, free services or goods, and so on). More specifically, the reward includes but is not limited to: 1) providing a free service, 2) providing a free product, 3) providing a service at a reduced cost, 4) providing a product at a reduced cost, 5) providing a coupon to obtain a free service or a free product, 6) providing a coupon to obtain a service or a product at a reduced cost, 7) providing a service operated by the service provider of the network for free or at a reduced cost, 8) providing an additional feature (e.g., call waiting, call forwarding, follow me forwarding, voicemail service, conference call service, messaging service, and so on) of a service currently operated by the service provider of the network for free or at a reduced cost, or 9) providing a cash rebate. It should be noted that the above list of rewards is only illustrative and is not intended to be an exhaustive list. The method then proceeds to step 385.

In step 380, method 300 provides the requested first content. For example, the method provides the customer the requested information without the participatory media content. The method then proceeds to step 385.

In optional step 385, method 300 determines if the customer wants to update preferences for receiving the participatory media content and/or profile. For example, the customer may want to change service subscription such that the customer may begin (or to terminate) receiving participatory media content. If the customer wants to opt-in (or opt-out) to receive the participatory media content and/or update the customer's profile, the method proceeds to optional step 390. Otherwise, the method ends in step 399 or returns to step 310 to continue receiving more requests.

In optional step 390, method 300 receives updates of preference for receiving the participatory media content and/or customer profile. For example, the customer may choose to opt-in (or opt-out) for receiving the participatory media content. The customer may create or update a profile that may be used to determine which contents the customer may wish to receive or not to receive. For example, a customer opting in may indicate that he only wants participatory media content relating to sports, whereas a customer who has previously opted in may adjust an existing profile such that participatory media content relating to the sports of hockey should not be sent because the customer is not a hockey fan, and so on. The method ends in step 399 or returns to step 310 to continue receiving more requests.

It should be noted that although not specifically specified, one or more steps of method 300 may include a storing, displaying and/or outputting step as required for a particular application. In other words, any data, records, fields, and/or intermediate results discussed in the method 300 can be stored, displayed and/or outputted to another device as required for a particular application. Furthermore, steps or blocks in FIG. 3 that recite a determining operation, or involve a decision, do not necessarily require that both branches of the determining operation be practiced. In other words, one of the branches of the determining operation can be deemed as an optional step.

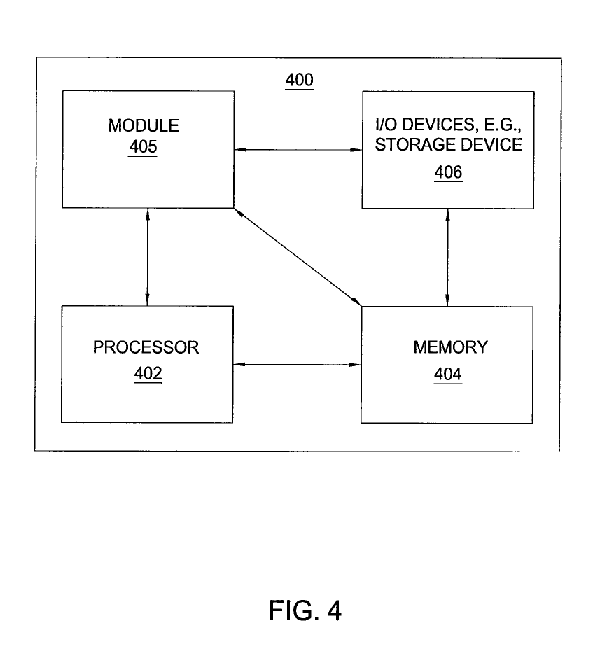

FIG. 4 depicts a high-level block diagram of a general-purpose computer suitable for use in performing the functions described herein. As depicted in FIG. 4, the system 400 comprises a processor element 402 (e.g., a CPU), a memory 404, e.g., random access memory (RAM) and/or read only memory (ROM), a module 405 for providing participatory media content in a network, and various input/output devices 406 (e.g., storage devices, including but not limited to, a tape drive, a floppy drive, a hard disk drive or a compact disk drive, a receiver, a transmitter, a speaker, a display, a speech synthesizer, an output port, and a user input device (such as a keyboard, a keypad, a mouse, and the like)).

It should be noted that the present invention can be implemented in software and/or in a combination of software and hardware, e.g., using application specific integrated circuits (ASIC), a general purpose computer or any other hardware equivalents. In one embodiment, the present module for providing participatory media content in a network or process 405 can be loaded into memory 404 and executed by processor 402 to implement the functions as discussed above. As such, the present method 405 for providing participatory media content in a network (including associated data structures) of the present invention can be stored on a computer readable medium or carrier, e.g., RAM memory, magnetic or optical drive or diskette and the like.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A method for providing content in a network, comprising:
receiving a request for a first content from a customer;
determining if said customer is associated with a service that provides a participatory media content;
selecting one or more participatory media content for said customer, if said customer is associated with said service; and
providing said customer with said one or more participatory media content and said first content.

2. The method of claim 1, further comprising:
determining if said customer has viewed at least one of said one or more participatory media content; and
updating a reward information for said customer for each of said one or more participatory media content that said customer has viewed.

3. The method of claim 2, wherein said reward information associated with each of said one or more participatory media content is different.

4. The method of claim 1, further comprising:
determining if said customer wants to update at least one preference for receiving said participatory media content; and
receiving an update for a profile of said customer, if said customer wants to update said at least one preference.

5. The method of claim 1, wherein said selecting is based on a profile of said customer.

6. The method of claim 5, wherein said profile of said customer is created with inputs provided by said customer.

7. The method of claim 5, wherein said profile is updated by analyzing said first content.

8. The method of claim 2, wherein said reward information is tracked to provide a reward to said customer.

9. The method of claim 8, wherein said reward comprises at least one of: providing a free service, providing a free product, providing a service at a reduced cost, providing a product at a reduced cost, providing a coupon to obtain a free service or a free product, providing a coupon to obtain a service or a product at a reduced cost, providing a service operated by a service provider of the network for free or at a reduced cost, providing an additional feature to said service operated by said service provider of the network for free or at a reduced cost, or providing a cash rebate.

10. The method of claim 2, wherein said reward information comprises a predefined reward that is specified by the customer.

11. The method of claim 1, wherein said selecting one or more participatory media content for said customer comprises:
determining a highest bidder; and
selecting one or more participatory media content of said highest bidder for said customer.

12. A computer-readable medium having stored thereon a plurality of instructions, the plurality of instructions including instructions which, when executed by a processor, cause the processor to perform steps of a method for providing content in a network, comprising:
receiving a request for a first content from a customer;
determining if said customer is associated with a service that provides a participatory media content;
selecting one or more participatory media content for said customer, if said customer is associated with said service; and
providing said customer with said one or more participatory media content and said first content.

13. The computer-readable medium of claim 12, further comprising:
determining if said customer has viewed at least one of said one or more participatory media content; and
updating a reward information for said customer for each of said one or more participatory media content that said customer has viewed.

14. The computer-readable medium of claim 12, further comprising:
determining if said customer wants to update at least one preference for receiving said participatory media content; and
receiving an update for a profile of said customer, if said customer wants to update said at least one preference.

15. The computer-readable medium of claim 12, wherein said selecting is based on a profile of said customer.

16. The computer-readable medium of claim 15, wherein said profile of said customer is created with inputs provided by said customer, or wherein said profile is updated by analyzing said first content.

17. The computer-readable medium of claim 13, wherein said reward information is tracked to provide a reward to said customer.

18. The computer-readable medium of claim 17, wherein said reward comprises at least one of: providing a free service, providing a free product, providing a service at a reduced cost, providing a product at a reduced cost, providing a coupon to obtain a free service or a free product, providing a coupon to obtain a service or a product at a reduced cost, providing a service operated by a service provider of the network for free or at a reduced cost, providing an additional feature to said service operated by said service provider of the network for free or at a reduced cost, or providing a cash rebate.

19. An apparatus for providing content in a network, comprising:
means for receiving a request for a first content from a customer;
means for determining if said customer is associated with a service that provides a participatory media content;
means for selecting one or more participatory media content for said customer, if said customer is associated with said service; and
means for providing said customer with said one or more participatory media content and said first content.

20. The apparatus of claim 19, further comprising:
means for determining if said customer has viewed at least one of said one or more participatory media content; and
means for updating a reward information for said customer for each of said one or more participatory media content that said customer has viewed.
